(19) United States
(12) Patent Application Publication
(10) Pub. No.: US 2011/0302393 A1
(43) Pub. Date: Dec. 8, 2011

(54) CONTROL SYSTEMS AND DATA PROCESSING METHOD

(76) Inventors: Noritaka Matsumoto, Tokai (JP); Tsutomu Yamada, Hitachinaka (JP); Akihiro Ohashi, Mito (JP); Shin Kokura, Hitachi (JP)

(21) Appl. No.: 13/153,724

(22) Filed: Jun. 6, 2011

(30) Foreign Application Priority Data
Jun. 8, 2010 (JP) 2010-130745

(51) Int. Cl. G06F 9/302

(52) U.S. Cl. 712/221; 712/E09.017

(57) ABSTRACT

When executing sequential processing such as a ladder logic, converting a program formed of an instruction set of another processor to a program executable by an own processor in software and then conducting processing lowers the real time property. In a control system, a storage unit stores a program for the own processor and a program for another processor. A processor reads data from the storage unit, executes processing described as a program, and gives an instruction to change over a method for acquiring data from the storage unit, to a conversion instruction unit according to data contents. A changeover unit is connected to the storage unit directly or via the conversion unit to change over the data acquiring method according to an instruction from the conversion instruction unit. The conversion unit converts data read from the storage unit to data executable by the processor, according to a conversion scheme.

### BACKGROUND OF THE INVENTION

The present invention relates to control systems using a computer which are utilized in FA (factory automation) and PA (process automation), and in particular to programmable logic controllers (PLCs) utilized in sequential control.

As personal computers become higher in function and network techniques represented by the Internet development, improvement of the processing speed and increase of the program capacity advance in control computers such as PLCs utilized in the fields of FA and PA. In addition, as for functions as well, the so-called five language corresponding function prescribed in IEC 61131-3 such as the ladder logic (LD (Ladder Diagram)), sequential function chart (SFC), function block diagram (FBD), structured text (ST) and instruction list (IL), and connection functions to various standard networks are needed. As the IT of the FA and PA systems has advanced in recent years, it is necessary to implement not only the conventional sequential control but also higher functions coping with multiple languages, and connection and communication functions to networks in this way. As a result, the configuration of the PLC is becoming complicated.

On the other hand, an increase of the development cost of the PLC caused by a higher function is posing a problem. It is becoming difficult to develop a dedicated LSI and manufacture a PLC capable of conducting real time processing as in the conventional technique.

For example, it is a conceivable method to use software on a general microcomputer instead of using a dedicated LSI to process the sequential control according to a ladder logic. In this case, a technique for converting a code of a ladder logic which is described for an another processor to a code for the own processor is needed. As such a conventional technique, an example in which a program codes described for a plurality of different processors is suitably changed over to be utilized for the own processor and executed is disclosed in JP-A-2008-171443. Furthermore, as a technique for improving the cost performance of the PLC, a scheme in which sophisticated arithmetic operation processing such as a function calculation is entrusted to a general purpose CPU is disclosed in JP-A-2005-141347.

### SUMMARY OF THE INVENTION

In JP-A-2008-171443 and JP-A-2005-141347, a technique for converting a program formed of instruction sets of another processor to a program for the own processor is described. In the technique, however, the program conversion is conducted by software processing. If real time processing such as sequential control is intended for, therefore, there is a fear that the processing speed will fall.

In view of the problem of the conventional techniques, an object of the present invention is to provide a novel control system capable of preventing the processing speed from being lowered by the program code conversion when executing a program described for another processor in the own processor.

In accordance with a first aspect of the present invention, a control system including an own processor for conducting arithmetic operation processing by using data including a program described for a plurality of different processors, and a storage device for storing data described for a plurality of different processors, includes a conversion unit for converting data in the storage device which differs from data for the own processor to the data for the own processor, a communication path for transmitting the data for the own processor in the storage device directly to the own processor, a communication path for converting the data which differs from the data for the own processor in the conversion unit and transmitting resultant data, a changeover unit for selecting one communication path from the communication paths and establish communication between the storage device and the own processor, and a conversion instruction unit for determining operation of the changeover unit according to a kind of data stored in the storage device.

Furthermore, the control system further includes a state retention unit for retaining a state of the changeover unit when an interruption has occurred in the own processor.

In accordance with a second aspect of the present invention, a data processing method in a control system including an own processor for conducting arithmetic operation processing by using data including a program described for a plurality of different processors, a storage device for storing data described for a plurality of different processors, a conversion unit for converting data in the storage device which differs from data for the own processor to the data for the own processor, a communication path for transmitting the data for the own processor in the storage device directly to the own processor, a communication path for converting the data which differs from the data for the own processor in the conversion unit and transmitting resultant data, a changeover unit for selecting one communication path from the communication paths and establish communication between the storage device and the own processor, and a conversion instruction unit for determining operation of the changeover unit according to a kind of data stored in the storage device, includes converting a program included in data in the storage device to a code for the own processor and processing the resultant code when at least one of a condition that a program in the data in the storage device is sequential processing, a condition that the program in the storage device is stored in a specific address, a condition that a specific code is included in the program in the storage device, and a condition that a specific interruption has occurred is satisfied, and processing the program in the storage device intact in the own processor when any of the conditions is not satisfied.

Furthermore, when converting a program for another processor stored in the storage device to a program for the own processor in the control system, a necessary bit string is extracted from the program for another processor, and if the bit string is an instruction code which can be discriminated in the control system, the program is converted to a machine code which can be executed directly in the own processor.

Furthermore, a plurality of instruction codes in a program for another processor are previously extracted, a plurality of machine codes are previously converted to be able to execute a plurality of machine codes in parallel, and converted machine codes are stored in the storage device in order of execution.

Furthermore, when converting a program for another processor stored in the storage device to a program for the own processor in the control system, a necessary bit string is extracted from the program for another processor, and if the bit string is an instruction code which can be discriminated in the control system, the program is converted to an intermediate language which can be executed by using the program for the own processor.

In accordance with a third aspect of the present invention, a control system including an own processor for conducting arithmetic operation processing by using data including a program described for a plurality of different processors, and a storage device for storing data described for a plurality of different processors, includes a conversion unit for converting data in the storage device which differs from data for the own processor to the data for the own processor, a control unit for managing changeover of data transmission to and reception from the storage device, a communication path for connecting the control unit directly to the own processor, and a communication path for connecting the control unit to the own processor via the conversion unit which conducts the conversion, the control unit selecting one communication path from the communication paths according to a kind of data stored in the storage device and causing the storage device and the own processor to conduct communication with each other.

Furthermore, the control system further includes a state retention unit for retaining a changeover state of the changeover unit when an interruption has occurred in the own processor.

Furthermore, the conversion unit for converting data for another processor stored in the storage device to the data for the own processor in the control system converts the data for another processor to the data for the own processor by dividing the data for another processor into a plurality of bit strings, taking out the bit strings, executing an arithmetic operation and bit string rearrangement every bit string obtained by the division, and thereby recomposing the bit strings into a data array for the own processor.

Furthermore, when executing an arithmetic operation and rearrangement on bit strings taken out, the conversion unit changes an arithmetic operation method and a rearrangement method of the bit strings according to an internal state of the control system or data acquired from external by the control system.

In accordance with a fourth aspect of the present invention, a data processing method in a control system including an own processor for conducting arithmetic operation processing by using data including a program described for a plurality of different processors, a storage device for storing data described for a plurality of different processors, a conversion unit for converting data in the storage device which differs from data for the own processor to the data for the own processor, a control unit for managing changeover of data transmission to and reception from the storage device, a communication path for connecting the control unit directly to the own processor, and a communication path for connecting the control unit to the own processor via the conversion unit which conducts the conversion, the control unit selecting one communication path from the communication paths according to a kind of data stored in the storage device and causing the storage device and the own processor to conduct communication with each other, includes, in response to satisfaction of at least one of a condition that a program in the data in the storage device is sequential processing, a condition that the program in the storage device is stored in a specific address, a condition that a specific code is included in the program in the storage device, and a condition that a specific interruption has occurred is satisfied, converting a program in the storage device to a data format which can be executed by the own processor, storing resultant converted data in the storage device, and causing the own processor to process the converted data.

Furthermore, when converting a program for another processor stored in the storage device to a program for the own processor in the control system, data is taken out from the program for another processor, and if the data taken out is data having a format prescribed in the control system, the data is converted to an intermediate language which can be executed by the own processor.

In accordance with a fifth aspect of the present invention, a control system including a plurality of processors which include an own processor and conduct arithmetic operation processing by using data including programs described for a plurality of different processors, and a storage device for storing data, includes a conversion unit having a plurality of conversion circuits which is responsive to data in the storage device different from data for some processor for converting the data different from data for the processor to data for some processor, and a control unit for managing changeover of data transmission to and reception between the plurality of processors and the storage device, the conversion unit including changeover units for changing over a conversion method by combining the plurality of conversion circuits according to a kind of data stored in the storage device.

Furthermore, the control system further includes a state retention unit for retaining a changeover state of the changeover unit when an interruption has occurred in the own processor.

Furthermore, the conversion unit for converting data for another processor stored in the storage device to data for the own processor in the control system conducts conversion to data formats for the plurality of processors by determining a method of the data conversion according to a conversion program stored in the storage device and changing the combination of the conversion circuits for the data conversion.

In accordance with a sixth aspect of the present invention, a data processing method in a control system including a plurality of processors which include an own processor and conduct arithmetic operation processing by using data including programs described for a plurality of different processors, a storage device for storing data, a conversion unit having a plurality of conversion circuits which is responsive to data in the storage device different from data for some processor for converting the data different from data for the processor to data for some processor, and a control unit for managing changeover of data transmission to and reception between the plurality of processors and the storage device, the conversion unit including changeover units for changing over a conversion method by combining the plurality of conversion circuits according to a kind of data stored in the storage device, includes, in response to data in the storage device which differs from the data for some processor, converting the data to a data format which can be executed by the some processor and conducting processing on resultant data.

Furthermore, if a program in the storage device is different from the program for the some processor when converting a program for another processor stored in the storage device to a program for the own processor in the control system, then data of the program is taken out, a conversion method of the data is determined according to a conversion program in the storage device, and the data is converted to a data format which can be executed by some processor in the control system.

According to the present invention, a control system including an own processor for conducting arithmetic operation processing by using data including a program described for a plurality of different processors, and a storage device for storing data described for a plurality of different processors, includes a conversion unit for converting data in the storage device which differs from data for the own processor to the data for the own processor, a communication path for transmitting the data for the own processor in the storage device directly to the own processor, a communication path for converting the data which differs from the data for the own processor in the conversion unit and transmitting resultant data, a changeover unit for selecting one communication path from the communication paths and establish communication between the storage device and the own processor, and a conversion instruction unit for determining operation of the changeover unit according to a kind of data stored in the storage device. As a result, a program for another processor can be executed on the own processor. Furthermore, since the program for another processor can also be emulated at high speed by making the speed of the own processor higher, it is facilitated to make the function of the whole system higher.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a control system according to a first embodiment of the present invention;

FIG. 2 is a flow chart showing a processing method in the control system according to the first embodiment of the present invention;

FIG. 3 is a diagram for explaining a program stored in a storage unit 3 in the first embodiment of the present invention;

FIG. 4 is a flow chart showing a processing method in a conversion unit 4 in the first embodiment of the present invention;

FIG. 5 is a diagram for explaining a ladder logic processed by the control system according to the first embodiment of the present invention;

FIG. 6 is a diagram for explaining a program stored in a storage unit 3 in the first embodiment;

FIG. 7 is a diagram for explaining a processor execution code in the control system according to the first embodiment;

FIG. 8 is a block diagram showing a configuration of a control system according to a second embodiment;

FIG. 9 is a flow chart showing a processing method in the control system according to the second embodiment of the present invention;

FIG. 10 is a flow chart showing a processing method in a conversion unit 13 in the second embodiment;

FIG. 11A is a diagram for explaining a stored program in a storage unit 12 in the second embodiment of the present invention;

FIG. 11B is a diagram for explaining a stored program in the storage unit 12 in the second embodiment of the present invention;

FIG. 12 is a conversion circuit diagram of a conversion unit 25 in the second embodiment according to the present invention;

FIG. 13 is a block diagram showing a configuration of a control system according to a third embodiment; and

FIG. 14 is a flow chart showing a processing method in the control system according to the third embodiment of the present invention.

### DESCRIPTION OF THE EMBODIMENTS

Hereafter, modes for carrying out the present invention will be described with reference to embodiments.

### First Embodiment

### (Basic Configuration)

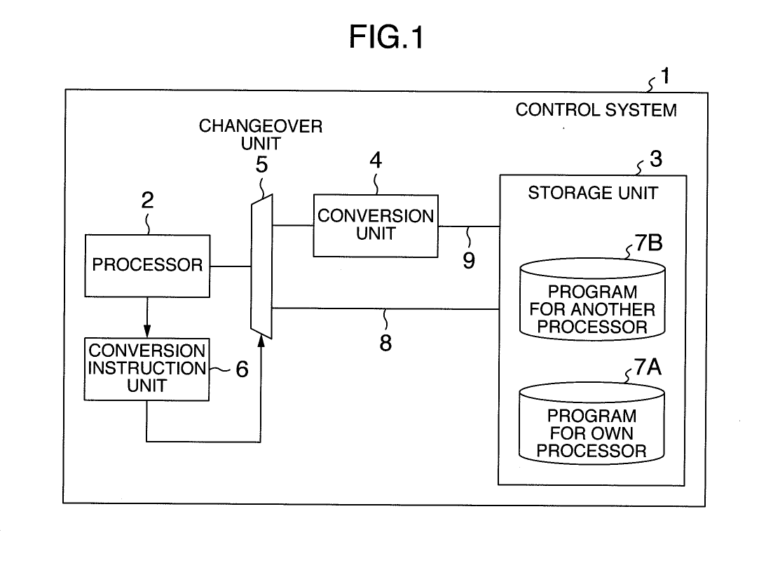

FIG. 1 shows a configuration example of a control system 1 according to a first embodiment of the present invention. The control system 1 includes a processor 2, a storage unit 3, a conversion unit 4, a changeover unit 5, and a conversion instruction unit 6. Instead of providing the conversion instruction unit 6 independently as shown in FIG. 1, the conversion instruction unit 6 may be incorporated in the processor 2 as one of functions in the processor 2 or may be integrated with the changeover unit 5. A program 7A for the own processor 2 and a program 7B for another processor are stored in the storage unit 3. These programs may also be stored in a storage unit formed of different hardware.

The processor 2 reads out program data from the storage unit 3, and executes described program processing. In addition, the processor 2 notifies the conversion instruction unit 6 of an instruction for changing over a method for acquiring data from the storage unit 3 according to contents of data. The storage unit 3 is formed of a volatile memory or a nonvolatile memory, and the storage unit 3 retains data such as a program. The conversion instruction unit 6 changes operation of the changeover unit 5 in response to the notice from the processor 2. The conversion instruction unit 6 and the processor 2 are connected to each other by an I/O interface such as I/O ports or serial ports or various buses such as the PCI or USB.

The changeover unit 5 is connected to the storage unit 3 directly via a communication path 8 or via a communication path 9 having the conversion unit 4. The changeover unit 5 changes over the method for reading data from the storage unit 3 in accordance with an instruction given by the conversion instruction unit 6. The conversion unit 4 converts data which is read from the storage unit 3 to data which can be processed by the processor 2, in accordance with a conversion scheme described later.

### (Basic Processing)

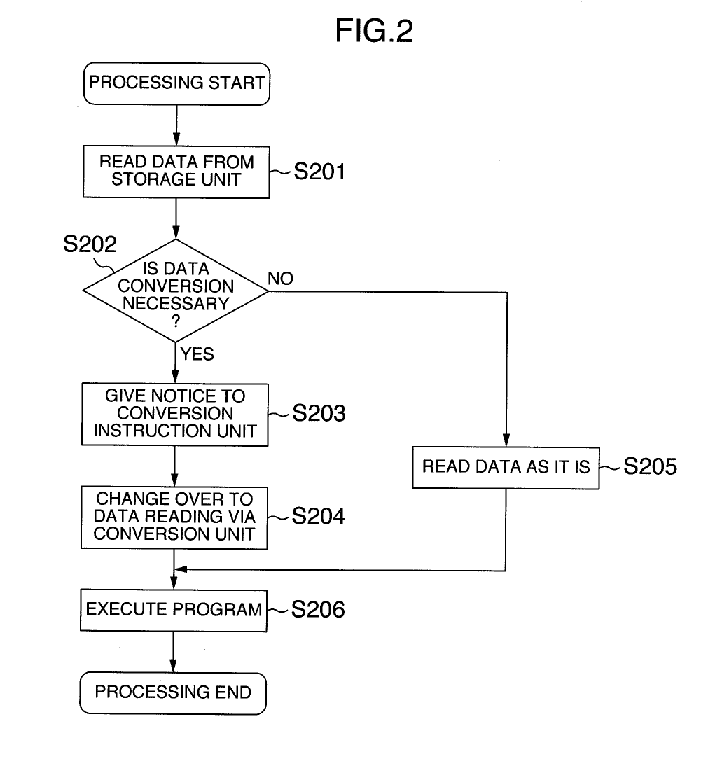

FIG. 2 shows a processing flow of the control system 1 according to the present invention. In processing steps, first, the processor 2 begins to read data such as a program from the storage unit 3 (S201), and makes a decision whether data conversion of the program which is read is necessary (S202). In other words, the processor 2 makes a decision whether the program is sequential processing formed of only instructions for which a PC (program counter) in the processor 2 continuously increases in value, or processing conducted by a usual application including a jump instruction in which an address indicated by the PC is skipped in execution.

If the program is sequential processing, then data conversion conducted by the conversion unit 4 is judged to be necessary, the processor gives a notice to the conversion instruction unit 6 (S203) and the changeover unit 5 changes over to data reading via the conversion unit 4 (S204). On the other hand, if the program is not sequence processing, then the changeover unit 5 is set to read data from the storage unit 3 as it is (S205). Finally, processing is executed according to program contents, and a result of the processing is stored in the storage unit 3 (S206). When storing data such as the processing result in the storage unit 3, a signal line or a data bus which is different from that used to read data may be used, or data may be stored in the storage unit 3 via the same signal line or data bus as that used to read data by setting the changeover unit 5 not to pass data through the conversion unit 4.

As for the decision method at S202, there is besides the above-described method, for example, a method of observing a value of an address indicated by the PC and checking whether an increase or decrease of at least a prescribed value has occurred. Furthermore, a decision may be made whether data conversion is necessary by reading an address in the storage unit 3 or a predetermined data format. For example, a decision may be made on the basis of an address of data stored in the storage unit 3, or a decision may be made on the basis of whether a specific code is included in data which has been read. In addition, the processor 2 or the conversion instruction unit 6 may be notified that the processing method is changed, by generating an interruption actively during execution of the program. In addition, a decision can be made by combining any of the above-described methods.

If an interruption to the processor 2 occurs during execution of S201 to S206 and it becomes necessary for the processor 2 to temporarily save states of its own register and the storage unit 3, information of the conversion instruction unit 6, i.e., the state of the changeover unit 5 is also saved in the storage unit 3 or a predetermined register. Even if, for example, an access from a device externally connected to the control system 1 or an interruption caused by a context switch in an OS (operating system) has occurred, this makes possible to continuously execute processing conducted before saving, at the time of restoration from temporary saving caused by an interruption.

(Decision as to whether Data Conversion is Necessary)

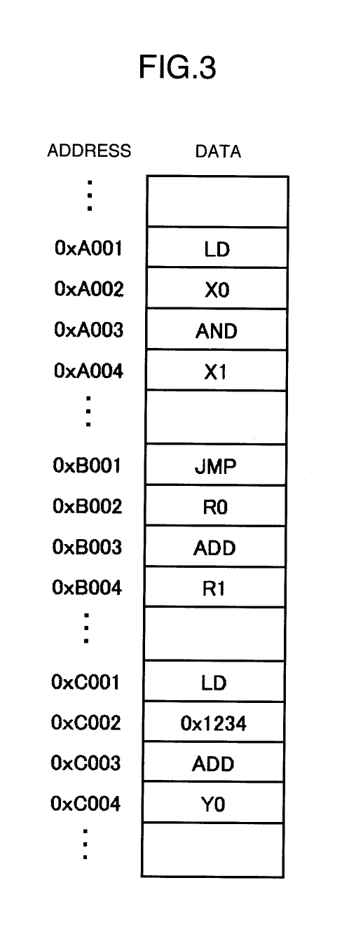

Hereafter, a concrete example of the decision method at S202 will be described with reference to FIG. 3. FIG. 3 shows an example of data stored in the storage unit 3. In the case where data in the range of address 0xA001 to address 0xA004 is read out, data which forms a program is only AND (logical conjunction instruction) of an LD (LOAD instruction) of a contact X0 (indicating specific address information) and a contact X1 (indicating specific address information) and the data does not include a jump instruction. Therefore, they can be judged to be sequential processing.

On the other hand, in the case where data in the range of address 0xB001 to address 0xB004 is read out, data which forms a program includes JMP (jump instruction) in addition to register information such as R0 and R1 and ADD (addition instruction). Therefore, the processor 2 judges them not to be sequential processing, and reads out data from the storage unit 3 without intervention of the conversion unit 4 and executes a program.

When data in the range of address 0xC001 to address 0xC004 is read out, a specific code such as, for example, 0x1234 is included besides instructions such as LD and ADD and Y0 (specific address information). Therefore, data conversion is judged to be necessary.

Besides them, a decision may be made on the basis of, for example, whether an operation code (bit pattern) indicating LD (LOAD instruction) is a code which can be interpreted directly by the processor 2. In addition, it is possible to previously set up a logic which generates an interruption, in a program and change over whether data conversion is necessary when a specific interruption has occurred in the processor 2. For example, when an output for a specific contact has occurred in the case where the program is the ladder logic, the data conversion of the program is suspended and changeover is conducted to transfer data directly to the processor 2. The processor can actively recognize that timing for changing over the data processing method is reached by specifying an external interruption terminal or the like of the processor 2 as a specific contact. Furthermore, the processor 2 itself may be notified to change over the data processing method by calling a function which generates a specific interruption, during execution of a program for the own processor 2.

### (Conversion Unit Processing)

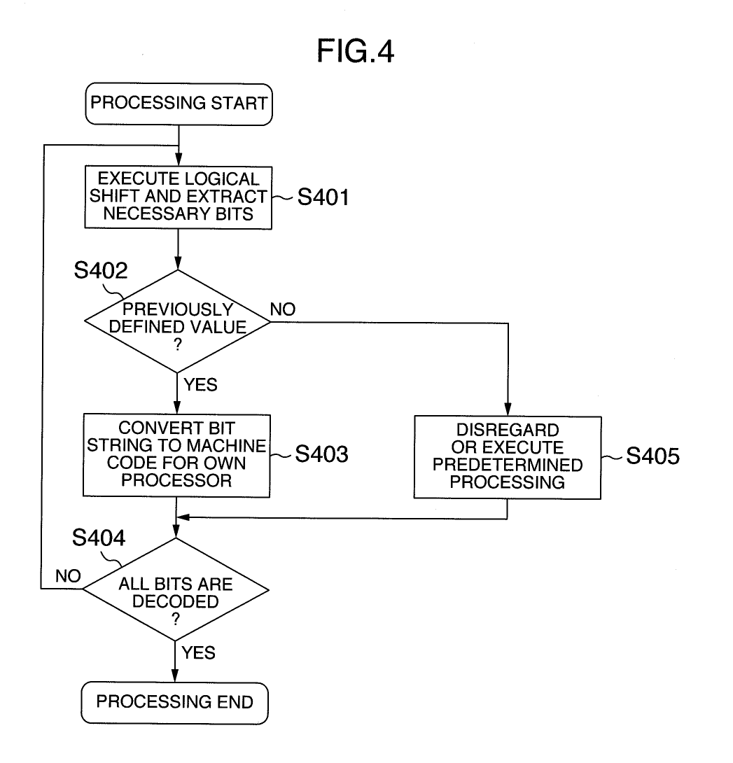

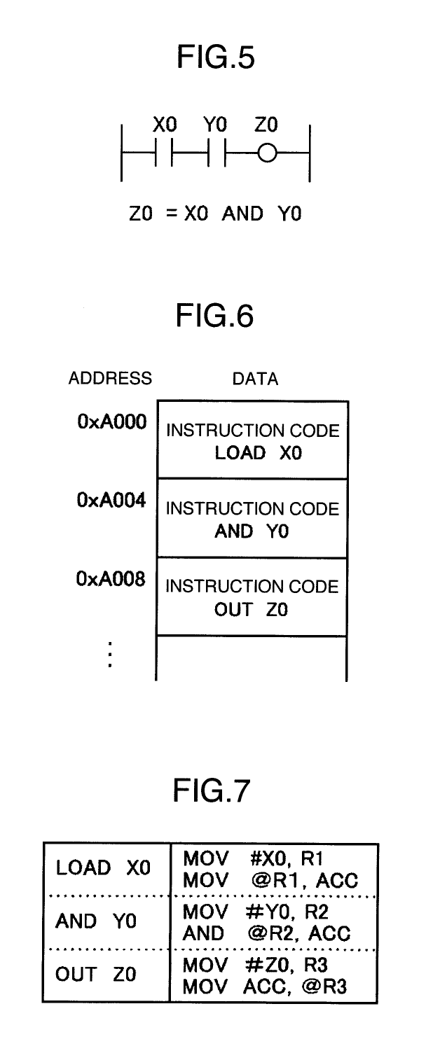

Respective steps in the processing flow of the conversion unit 4 will now be described with reference to FIG. 4. As an example, a program which processes a ladder logic as shown in FIG. 5 is supposed. The ladder logic in FIG. 5 shows sequential processing which conducts operation to find a logical product of a value of a contact X0 and a value of a contact Y0 and outputs the logic product to a contact Z0, and the ladder logic is stored in the storage unit 3 in, for example, a data format shown in FIG. 6. In other words, it is supposed that an instruction code which loads the value of the contact X0 in a 32-bit area beginning with the address 0xA000, the value of the contact Y0 and an instruction code which conducts an arithmetic operation to find a logical product are stored in a 32-bit area beginning with the address 0xA004, and an instruction code which outputs a result of the arithmetic operation to the contact Z0 is stored in a 32-bit area beginning with the address 0xA008. It is now supposed that the instruction codes of the ladder logic stored in the storage unit 3 are codes for another processor.

As shown in FIG. 4, the conversion unit 4 first executes a logical shift operation on an instruction code and extracts a specific bit string (S401). Then, the conversion unit 4 makes a decision whether the extracted bit string is a previously defined value by referring to table information and collating a bit pattern (S402). If the extracted bit string is a previously defined value, the conversion unit 4 converts the extracted bit string to a machine code for the own processor 2 (S403). For example, if the conversion unit 4 reads out a code corresponding to 32 bits from the address 0xA001 and judges the code to be LOAD to the contact X0, then the conversion unit 4 converts the code to a machine code which executes an assembler code shown in FIG. 7. In the same way, if instruction codes are AND with respect to the contact Y0 and output to the contact Z0, then the conversion unit 4 converts the instruction codes respectively to codes shown in FIG. 7. MOV in FIG. 7 indicates a data transfer instruction, and AND indicates a logical conjunction operation instruction, and they are codes which can be interpreted by the processor 2 in the control system 1.

In FIG. 7, #X0, #Y0 and #Z0 represent memory addresses corresponding to the contacts X0, Y0 and Z0, respectively, R1, R2 and R3 represent registers in the processor 2, and ACC represents an accumulator. In FIG. 7, @ is a symbol indicating an effective address, and @R1 indicates that contents of the register R1 are an effective address. Therefore, “MOV #X0 R1” represents to transfer an address value of the contact XO to the register R1, and “MOV @R1 ACC” represents to transfer data at an address indicated by the register R1 to the accumulator ACC.

In other words, “MOV #X0 R1” and “MOV @R1 ACC” correspond to execution of “LOAD X0” of the ladder logic. In the same way, “MOV #Y0 R2” represents to transfer an address value of the contact Y0 to the register R2, and “MOV @R2 ACC” represents to calculate a logical conjunction of data at an address indicated by the register R2 and a value in the accumulator ACC and return the logical product to the accumulator ACC. Therefore, “MOV #Y0 R2” and “MOV @R2 ACC” correspond to execution of “AND Y0” of the ladder logic.

In the same way, “MOV #Z0 R3” represents to transfer an address value of the contact Z0 to the register R3, and “MOV ACC @R3” represents to transfer the value in the accumulator ACC to an address indicated by the register R3. Therefore, “MOV #Z0 R3” and “MOV ACC @R3” correspond to execution of “OUT Z0” of the ladder logic.

By the way, if a contact such as XO is data of a bit unit, processing for extracting only pertinent bits by using a shift operation or the like from data taken from a memory with several bytes taken as the unit is necessary. However, description of the processing will be omitted to simplify the description. It is possible to execute a program at high speed by converting an instruction of the ladder logic directly to a machine code in the processor 2 in this way.

Here, three codes “MOV #X0, R1”, “MOV #Y0, R2”, and “MOV #Z0, R3” can be executed in parallel by pipeline processing or the like in the processor 2. Therefore, codes which can be executed in parallel may be processed in a lump by previously acquiring the entire ladder logic. In this case, a further higher speed can be attained by storing converted machine codes in the storage unit 3 in the order of execution and conducting parallel processing.

On the other hand, if the extracted value as shown in FIG. 4 is not an already defined value, then nothing is done or predetermined processing is executed (S405). As the predetermined processing, there are, for example, methods such as interruption of the processing or transfer of the extracted value intact to the processor 2 without converting the value. Finally, a decision is made whether conversion (decoding) of all bits of the data taken out is completed (S404). If decoding of the whole data is not completed, S401 to S403 are repeated. As described heretofore, the conversion unit 4 decodes the code for another processor to the code for the own processor 2.

The processing in the conversion unit 4 may be implemented wholly by hardware as logic circuits or processed partially by software. Furthermore, in the processing in the conversion unit 4, the code for another processor may be converted to an intermediate language which can be processed in the own processor 2 by using a specific program and the intermediate language may be stored in the storage unit 3, instead of converting the code for another processor to a machine code which can be executed directly by the own processor 2. In this case, there is an advantage that the configuration of the conversion unit 4 can be simplified although the processing speed is lowered as compared with the case where conversion to an assembler code is conducted.

For example, in the case where the ladder logic for another processor is executed in the own processor 2 in the conventional technique, a program for code conversion is called from the storage unit 3 and processed as occasion demands. Therefore, there is a possibility that a plurality of memory accesses will occur, resulting in a lowered real time property and a lowered processing speed. A ladder logic for another processor can be converted to an assembler code formed of several instructions for the own processor 2 by using the present invention. Therefore, it becomes possible to prevent the real time property and the processing speed from falling.

According to the present invention, therefore, it becomes possible to process a program in the own processor 2 at high speed and in real time no matter whether the program is the program for the own processor 2 or the program for another processor. In addition, if only performance of the own processor 2 is improved, the processing speed of the program for another processor can also be improved.

Furthermore, the ladder logic needs to cope with an extended instruction for executing complicated function processing or the like besides an ordinary operation such as a simple logical operation. In some cases, the extended instruction is processed by a processor which is different from that for the ordinary instruction. Since the ordinary instruction and the extended instruction are processed by different processors, therefore, there is a problem that the execution speed of the extended instruction significantly falls as compared with that of the ordinary instruction. According to the present invention, however, it becomes possible to process the extended instruction as well at an execution speed equivalent to that of the ordinary instruction by causing the processor 2 in the control system 1 to execute the extended instruction as a program for the processor 2.

### Second Embodiment

### (Basic Configuration)

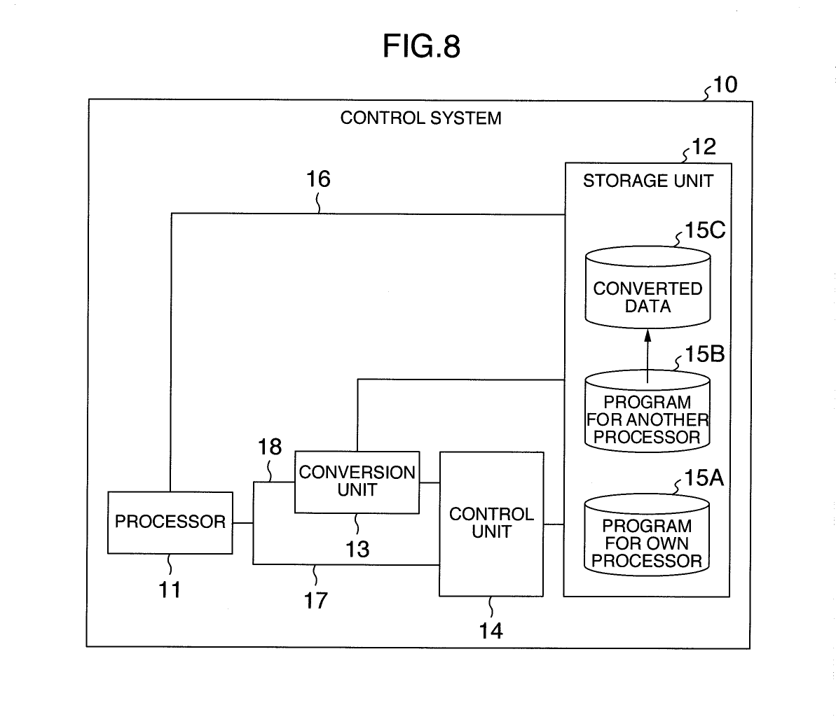

Hereafter, a second embodiment of the present invention will be described in detail with reference to the drawings. FIG. 8 is a diagram showing a configuration example of a control system 10 according to the present invention. The control system 10 includes a processor 11, a storage unit 12, a conversion unit 13, and a control unit 14. A program 15A for the own processor 11 and a program 15B for another processor 11 are stored in the storage unit 12. These programs may be stored in the storage units 12 respectively formed of different hardware pieces.

The processor 11 reads out data from the storage unit 12 via the control unit 14 and the conversion unit 13, and executes processing described as a program. The processor 11 has a communication path 16 which can be connected directly to the storage unit 12. The storage unit 12 is formed of a volatile memory or a nonvolatile memory, and the storage unit 12 retains data such as a program.

The control unit 14 controls data transmission and reception of the processor 11 and the storage unit 12, and exercises changeover control to determine whether to transfer data read from the storage unit 12 according to its own decision intact to the processor 11 via a communication path 17 or whether to transfer the data via a communication path 18 having the conversion unit 13. It is also possible to control this changeover function according to an instruction given by the processor 11.

The conversion unit 13 converts the data read from the storage unit 12, according to a conversion scheme described later. The conversion unit 13 may have a function similar to that of the conversion unit 13 in the first embodiment. Furthermore, although the conversion unit 13 is connected to the storage unit 12 via the control unit 14, the conversion unit 13 may be connected directly to the storage unit 12. Furthermore, although the conversion unit 13 is connected directly to the processor 11 by a conversion unit processing scheme described later, a configuration in which the conversion unit 13 is not connected directly to the processor 11 is also possible. Furthermore, the conversion unit 13 and the control unit 14 may be unified and formed as the same hardware.

### (Basic Processing)

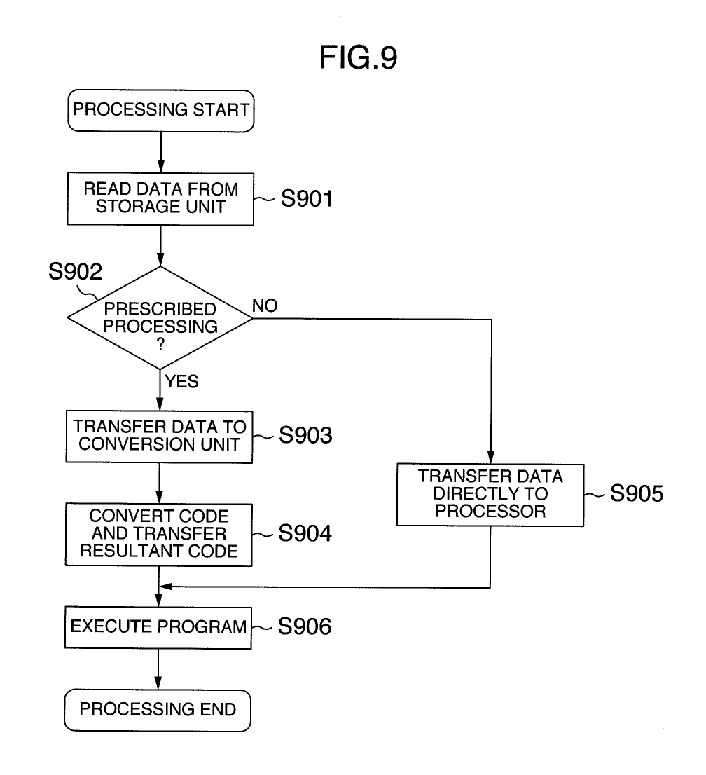

FIG. 9 shows a processing flow of the control system 10 according to the present embodiment. First, the processor 11 begins to read data such as a program from the storage unit 12 via the control unit 14 (S901). Then, a decision is made whether the program which is read is prescribed processing which needs data conversion such as, for example, specific sequential processing (S902). The decision at S902 is made by the control unit 14 itself. It is also possible to transfer the data to the processor 11 once and cause the processor 11 to make a decision and notify the control unit 14 of a result of the decision.

If the program is prescribed processing, the data is transferred to the conversion unit 13 (S903). In the same way, the conversion unit 13 converts a code for another processor to a code for the own processor 11 and transfers the resultant code to the processor 11 (S904).

On the other hand, if the control unit 14 has judged that the program is not prescribed processing but is, for example, a program for the own processor 11, then the control unit 14 transfers data directly to the processor 11 (S905). The processor 11 executes processing which depends upon the received program and stores data of the processing result in the storage unit 12 directly or via the control unit 14 (S906).

As for S902, a decision may be made by using a method for making a decision on the basis of the address in the storage unit 12, a method for making a decision on the basis of whether a specific code is included, a method for generating an interruption actively during the program execution, or a method obtained by combining a plurality of the above-described methods, besides the method for making a decision on the basis of whether the program is sequential processing, in the same way as the first embodiment.

If an interruption to the processor 11 occurs during execution of S901 to S906 and it becomes necessary for the processor 11 to temporarily save the state of its own register or the storage unit 12, then information concerning whether the conversion unit is utilized in the control unit is saved in the storage unit or a predetermined register. Upon restoration from temporary saving caused by an interruption, therefore, it becomes possible to continue and execute the processing conducted before the saving.

### (Processing in Conversion Unit)

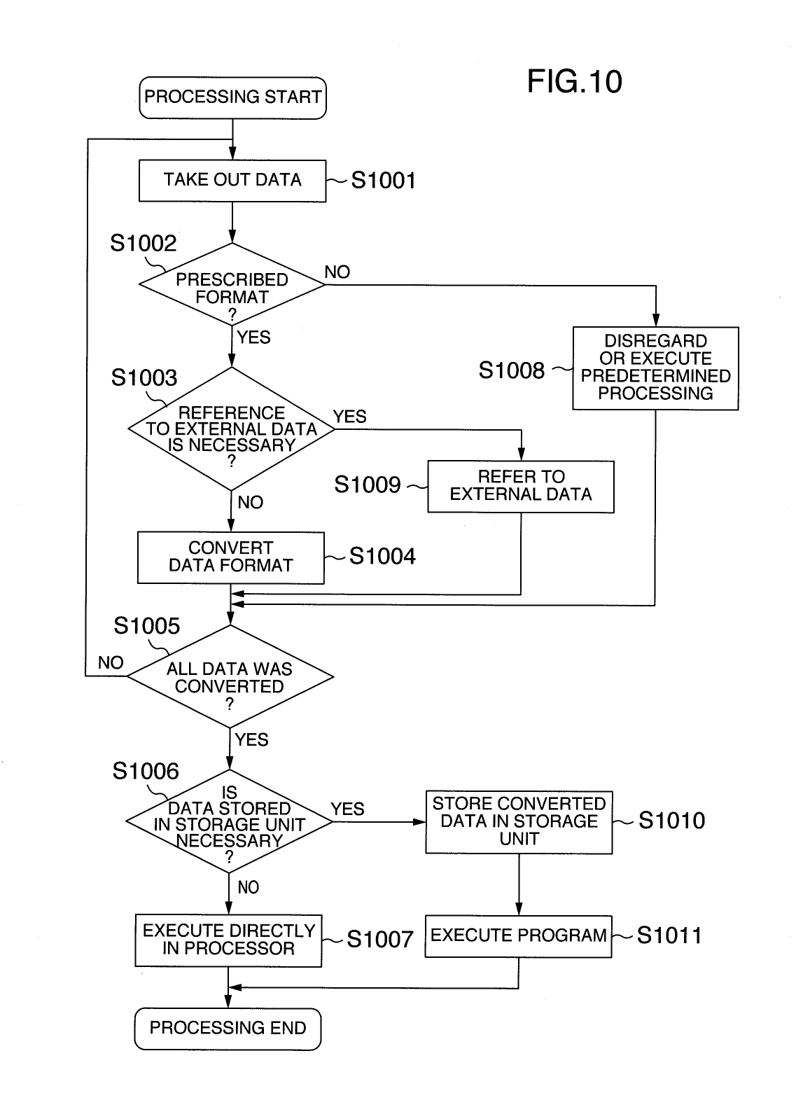

Processing in the conversion unit 13 in the second embodiment is executed according to a processing flow shown in FIG. 10. Furthermore, utterly the same processing as that in the conversion unit 13 in the first embodiment may be conducted. Hereafter, the processing flow of the conversion unit 13 in the present second embodiment will be described.

First, the conversion unit 13 takes out data in the storage unit 12 via the control unit 14 (S1001). Data takeout may be conducted by taking a bit as the unit according to hardware, or it is possible to take out data by taking a byte as the unit and take out every bit by a shift operation. Then, the conversion unit 13 makes a decision whether the received data has a prescribed data format (S1002). In the case of the prescribed data format, then the conversion unit 13 makes a decision whether reference to external data is necessary (S1003). As for the external data, there is, for example, data stored in the storage unit 12, and register information in the CPU or the control unit 14. If the received data hasn't a prescribed data format, the conversion unit 13 does nothing or executes predetermined processing such as processing termination (S1008).

If reference to external data is necessary, external data is taken in by software execution or register access (S1009). Then, conversion of the data format is executed (S1004). Here, a conversion method may be changed according to a value of external data taken in at S1009. Then, a decision is made whether takeout and conversion of all data have been completed (S1005). If the conversion of all data is not completed, S1001 to S1004 are executed repetitively.

If conversion of all data is completed, a decision is made whether to store the converted data in the storage unit 12 (S1006). If conversion to a machine code which can be executed directly by the processor 11 is conducted, then, for example, the machine code may be processed directly by the processor 11 without storing data in the storage unit 12 as shown in the first embodiment (S1007). On the other hand, if the data is converted to a data format which cannot be executed directly by the processor 11, such as, for example, an intermediate language, then resultant data is stored in the storage unit 12 as converted data 15C (S1010). In this case, the processor 11 processes the converted data by, for example, executing the program for the own processor 11 (S1011).

### (Data Format Conversion Method)

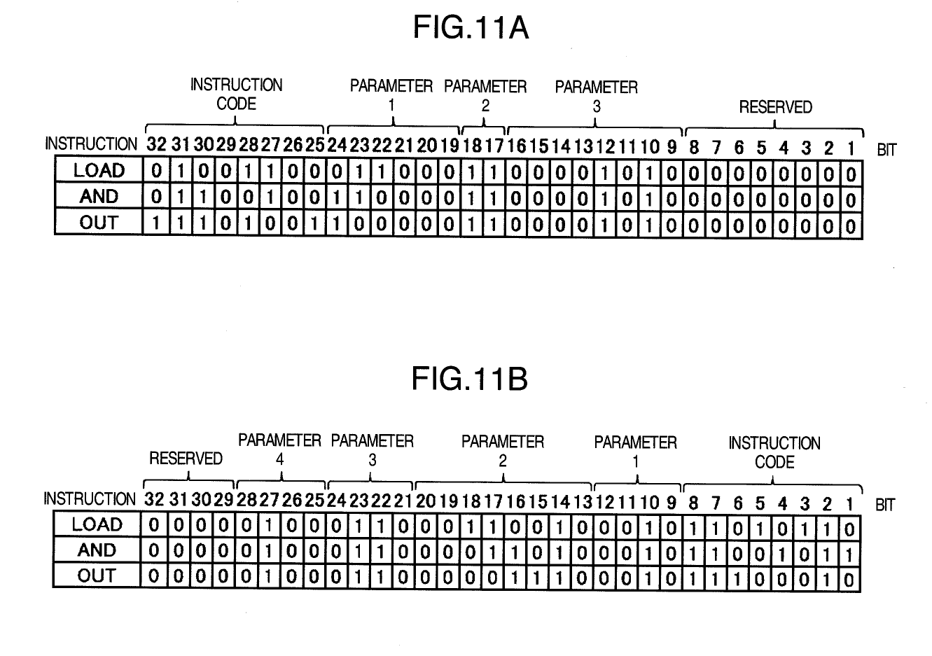

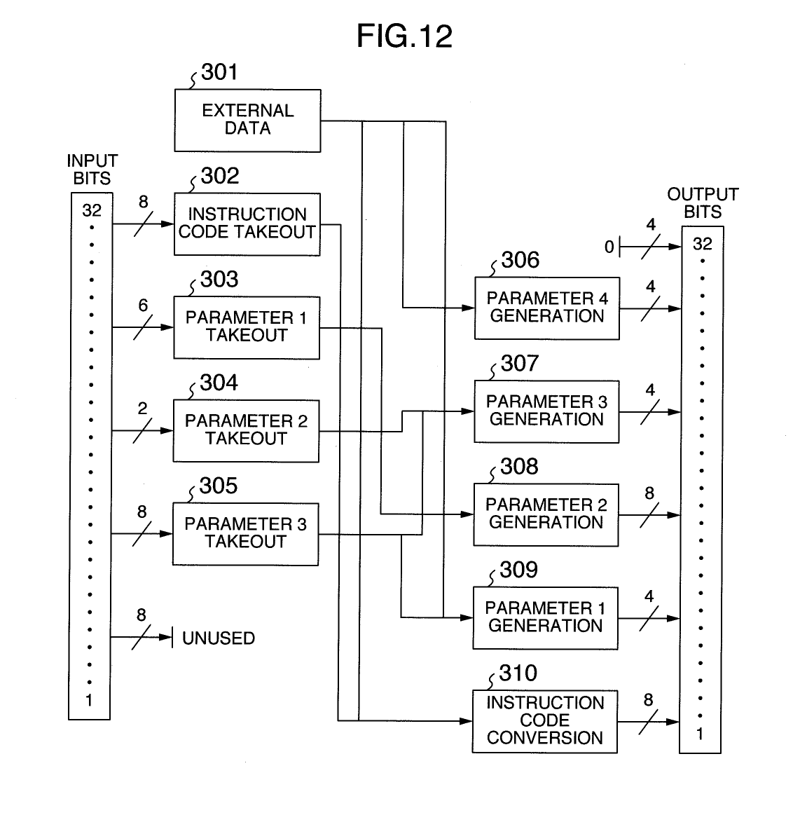

An example of a data format conversion method at S1004 will now be described. As shown in FIG. 11A, the ladder logic is stored in a data format of the program for another processor. The conversion unit 13 takes out a part which corresponds to an instruction code and converts it to an instruction code in the program for the own processor 11. For example, in the data format of the program for another processor, a LOAD instruction is represented by a bit pattern 00110010 in a region of the 25th bit to the 32nd bit. As shown in FIG. 11B, it is converted to a bit pattern 01101011 in a region of the 1st bit to the 8th bit as a data format of the program for the own processor 11. In the same way, parameters in the program for another processor are also taken out one after another and converted to a data format of the related program for the own processor 11. These kinds of processing may be executed by software, or may be executed by hardware (logic circuits), for example, shown in FIG. 12.

Processing in the case where data conversion is executed by hardware shown in FIG. 12 will now be described. First, an instruction code and parameters are taken out from input bits by operation circuits 302 to 305. Conversion of the instruction code can be executed by, for example, table reference or the like. Respective parameters are also generated sequentially as a format of the program for the own processor 11 according to prescribed operation circuits 306 to 310. Reference numeral 301 denotes external data.

Here, values of parameters to be generated may be determined by referring to, for example, hardware information such as I/O of input switches mounted on the control system 10, the software state, and register values as external data. Furthermore, data in the reserved area and the like may be previously set as 0 fixed in hardware.

According to the second embodiment, the ladder logic described for another processor can be converted on the own processor 11 and executed at high speed as described heretofore. Furthermore, programs for another processor of a plurality of kinds can be converted to the program for the own processor 11 and utilized by changing over the conversion method in the reference to external data.

### Third Embodiment

Hereafter, a third embodiment of the present invention will be described in detail with reference to the drawings. The third embodiment shows an example in which the present invention is used together with the dedicated processor/program which is the old resource in the conventional technique.

### (Basic Configuration)

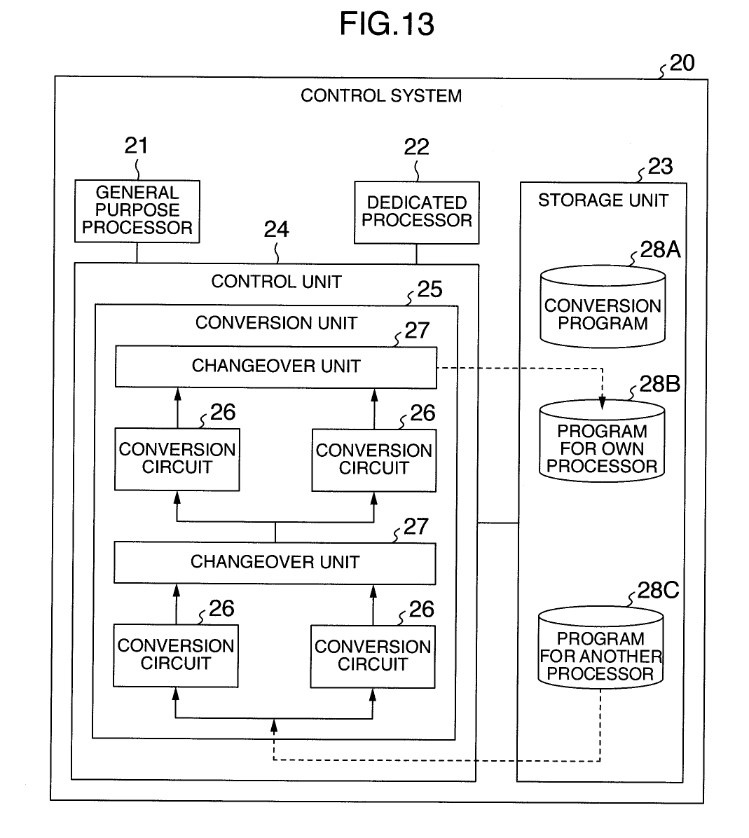

FIG. 13 shows a configuration example of a control system 20 according to the present invention. The control system 20 includes a general purpose processor 21, a dedicated processor 22, a storage unit 23, and a control unit 24. A conversion program 28A for the general purpose processor 21, a program 28B for own processor for the dedicated processor 22, and a program 28C for another processor are stored in the storage unit 23. These programs may be stored in storage units 23 which are formed respectively of different hardware pieces.

The general purpose 21 reads out data from the storage unit 23 via the control unit 24 or a conversion unit 25, and executes processing according to a program. The dedicated processor 22 reads out data from the storage unit 23 via the control unit 24 or the conversion unit 25, and executes processing according to a program. In the present example, the general purpose processor 21 is defined as a processor for executing an OS and various applications mounted on the OS, and the dedicated processor 22 is defined as a processor for executing sequential processing represented by the ladder logic. There may be a plurality of general purpose processors 21 and a plurality of dedicated processors 22. The general purpose processor 21 and the dedicated processor 22 may be made as the same hardware.

The storage unit 23 is formed of a volatile memory or a nonvolatile memory, and the storage unit 23 retains data such as a program. The storage unit 23 may be connected directly to the general purpose processor 21 and the dedicated processor 22. The control unit 24 controls data transmission and reception between the storage unit 23 and the general purpose processor 21 and the dedicated processor 22 on the basis of an instruction given by a processor or its own decision, and has a function of the conversion unit 25 described later.

The conversion unit 25 includes conversion circuits 26 and changeover units 27. In the same way as the first embodiment and the second embodiment, the conversion unit 25 converts the data read from the storage unit 23, according to a conversion scheme described later, and causes a processor to read resultant data directly or via the storage unit 23. The conversion unit 25 may be provided externally to the control unit 24, and connected to the control unit 24 or the dedicated processor 22.

The conversion circuit 26 converts a program for another processor to a program for own processor. The changeover unit 27 selects a suitable one from a plurality of conversion circuits in accordance with a conversion program.

### (Basic Processing)

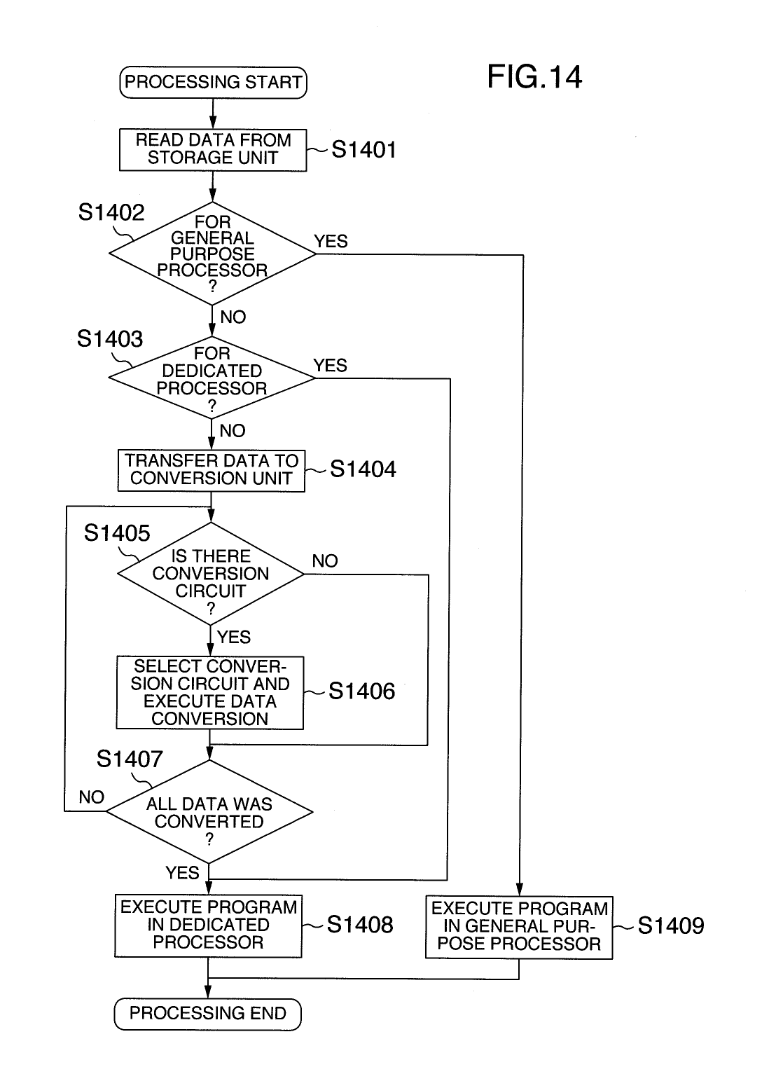

FIG. 14 shows a processing flow of the control system 20 according to the present embodiment. First, the control unit 24, or the processor 21 or 22 reads data from the storage unit 23 (S1401). Then, a decision is made whether the data which is read is a program for the general purpose processor 21 (S1402). If the data which is read is a program for the general purpose processor 21, then the general purpose processor 21 executes the program (S1409).

On the other hand, if the data which is read is not a program for the general purpose processor 21, then a decision is made whether the data is a program for the dedicated processor 22 (S1403). If the data which is read is a program for the dedicated processor 22, then the dedicated processor 22 executes the program.

Here, the order of S1402 and S1403 may be reversed. As for the method for making a decision which processor the program which is read corresponds to, there are, for example, a method of storing programs by dividing an address region in the storage unit 23 to correspond to respective processors, a method of providing a special code which indicates a classification of a program at head of data, a method of checking whether data which is read includes an instruction code which can be interpreted by each processor, a method of generating a specific interruption if a program is executed is properly executed in a corresponding processor. Furthermore, a plurality of methods among these methods may be combined.

If the data is neither a program for the general purpose processor 21 nor a program for the dedicated processor 22, then the data is transferred to the conversion unit 25 (S1404). Then, the conversion unit 25 makes a decision whether there is a conversion circuit 26 corresponding to a format of the received data (S1405). For example, in the case of data for another processor as shown in FIG. 11A, the conversion unit 25 makes a decision whether there is a conversion circuit 26 which accepts a bit pattern 00110010 of an instruction code indicating the LOAD instruction as an input. A conversion program for the general processor 21 may execute this decision by table reference, or may execute this decision by using a logical circuit which conducts conditional jump every bit. If a bit pattern coincides, then a selection of a conversion circuit 26 is conducted and data conversion is executed (S1406).

If there are a plurality of conversion circuits 26 for one bit pattern, the conversion program for the general processor 21 may support the selection. For example, the conversion program previously sets a flag in a specific register according to user's setting and selects a conversion circuit 26 to be used, by referring to a state of the flag. If a program is sequential processing such as a ladder logic, then it is also possible to put together a plurality of instructions or every specific data size and execute the selection of a conversion circuit 26 and data conversion.

Then, a decision is made whether the conversion is completed for all data (S1407). If conversion of all data is not completed, then S1405 to S1406 are executed repetitively. If conversion of all data is completed, then data may be delivered directly to the dedicated processor 22 or the data may be stored in the storage unit 23 as a converted program for own processor and then processed in the dedicated processor 22 (S1408).

If an interruption occurs in the general purpose processor 21 or the dedicated processor 22 during execution of S1401 to S1409 and it becomes necessary to temporarily save states of its own register and the storage unit 23, then states of conversion circuits and changeover units in the control unit are saved in the storage unit 23 and predetermined registers. When restoration from temporary saving caused by an interruption is conducted, therefore, it becomes possible to execute processing conducted before the saving, continuously.

According to the present invention, it becomes possible to convert programs of a plurality of kinds, such as ladder logics for another processor, fast as programs for the own processor and process them in real time, as described heretofore.

It should be further understood by those skilled in the art that although the foregoing description has been made on embodiments of the invention, the invention is not limited thereto and various changes and modifications may be made without departing from the spirit of the invention and the scope of the appended claims.

1. A control system including an own processor for conducting arithmetic operation processing by using data including a program described for a plurality of different processors, and a storage device for storing data described for a plurality of different processors, the control system comprising:
a conversion unit for converting data in the storage device which differs from data for the own processor, to the data for the own processor;
a communication path for transmitting the data for the own processor in the storage device directly to the own processor;
a communication path for converting the data which differs from the data for the own processor in the conversion unit and transmitting resultant data;
a changeover unit for selecting one communication path from the communication paths and establish communication between the storage device and the own processor; and
a conversion instruction unit for determining operation of the changeover unit according to a kind of data stored in the storage device.

2. The control system according to claim 1, further comprising a state retention unit for retaining a state of the changeover unit when an interruption has occurred in the own processor.

3. A data processing method in a control system including an own processor for conducting arithmetic operation processing by using data including a program described for a plurality of different processors, a storage device for storing data described for a plurality of different processors, a conversion unit for converting data in the storage device which differs from data for the own processor to the data for the own processor, a communication path for transmitting the data for the own processor in the storage device directly to the own processor, a communication path for converting the data which differs from the data for the own processor in the conversion unit and transmitting resultant data, a changeover unit for selecting one communication path from the communication paths and establish communication between the storage device and the own processor, and a conversion instruction unit for determining operation of the changeover unit according to a kind of data stored in the storage device,
the data processing method in control system comprising:
converting a program included in data in the storage device to a code for the own processor and processing the resultant code when at least one of a condition that a program in the data in the storage device is sequential processing, a condition that the program in the storage device is stored in a specific address, a condition that a specific code is included in the program in the storage device, and a condition that a specific interruption has occurred is satisfied; and
processing the program in the storage device intact in the own processor when any of the conditions is not satisfied.

4. The data processing method in control system according to claim 3, wherein
when converting a program for another processor stored in the storage device to a program for the own processor in the control system, a necessary bit string is extracted from the program for another processor, and
if the bit string is an instruction code which can be discriminated in the control system, the program is converted to a machine code which can be executed directly in the own processor.

5. The data processing method in control system according to claim 3, wherein
a plurality of instruction codes in a program for another processor are previously extracted,
a plurality of machine codes are previously converted to be able to execute a plurality of machine codes in parallel, and
converted machine codes are stored in the storage device in order of execution.

6. The data processing method in control system according to claim 3, wherein
when converting a program for another processor stored in the storage device to a program for the own processor in the control system, a necessary bit string is extracted from the program for another processor, and
if the bit string is an instruction code which can be discriminated in the control system, the program is converted to an intermediate language which can be executed by using the program for the own processor.

7. A control system including an own processor for conducting arithmetic operation processing by using data including a program described for a plurality of different processors, and a storage device for storing data described for a plurality of different processors, the control system comprising:
a conversion unit for converting data in the storage device which differs from data for the own processor, to the data for the own processor;
a control unit for managing changeover of data transmission to and reception from the storage device;
a communication path for connecting the control unit directly to the own processor; and
a communication path for connecting the control unit to the own processor via the conversion unit which conducts the conversion,
the control unit selecting one communication path from the communication paths according to a kind of data stored in the storage device and causing the storage device and the own processor to conduct communication with each other.

8. The control system according to claim 7, further comprising a state retention unit for retaining a changeover state of the changeover unit when an interruption has occurred in the own processor.

9. The control system according to claim 7, wherein the conversion unit for converting data for another processor stored in the storage device to the data for the own processor in the control system converts the data for another processor to the data for the own processor by dividing the data for another processor into a plurality of bit strings, taking out the bit strings, executing an arithmetic operation and bit string rearrangement every bit string obtained by the division, and thereby recomposing the bit strings into a data array for the own processor.

10. The control system according to claim 9, wherein when executing an arithmetic operation and rearrangement on bit strings taken out, the conversion unit changes an arithmetic operation method and a rearrangement method of the bit strings according to an internal state of the control system or data acquired from external by the control system.

11. A data processing method in a control system including an own processor for conducting arithmetic operation processing by using data including a program described for a plurality of different processors, a storage device for storing data described for a plurality of different processors, a conversion unit for converting data in the storage device which differs from data for the own processor to the data for the own processor, a control unit for managing changeover of data transmission to and reception from the storage device, a communication path for connecting the control unit directly to the own processor, and a communication path for connecting the control unit to the own processor via the conversion unit which conducts the conversion, the control unit selecting one communication path from the communication paths according to a kind of data stored in the storage device and causing the storage device and the own processor to conduct communication with each other,
the data processing method in control system comprising:
in response to satisfaction of at least one of a condition that a program in the data in the storage device is sequential processing, a condition that the program in the storage device is stored in a specific address, a condition that a specific code is included in the program in the storage device, and a condition that a specific interruption has occurred is satisfied,
converting a program in the storage device to a data format which can be executed by the own processor;
storing resultant converted data in the storage device; and
causing the own processor to process the converted data.

12. The data processing method in control system according to claim 11, wherein
when converting a program for another processor stored in the storage device to a program for the own processor in the control system, data is taken out from the program for another processor, and
if the data taken out is data having a format prescribed in the control system, the data is converted to an intermediate language which can be executed by the own processor.

13. A control system including a plurality of processors which include an own processor and conduct arithmetic operation processing by using data including programs described for a plurality of different processors, and a storage device for storing data, the control system comprising:
a conversion unit having a plurality of conversion circuits which is responsive to data in the storage device different from data for some processor for converting the data different from data for the processor to data for some processor; and
a control unit for managing changeover of data transmission to and reception between the plurality of processors and the storage device;
the conversion unit comprising changeover units for changing over a conversion method by combining the plurality of conversion circuits according to a kind of data stored in the storage device.

14. The control system according to claim 13, further comprising a state retention unit for retaining a changeover state of the changeover unit when an interruption has occurred in the own processor.

15. The control system according to claim 13, wherein the conversion unit for converting data for another processor stored in the storage device to data for the own processor in the control system conducts conversion to data formats for the plurality of processors by determining a method of the data conversion in accordance with a conversion program stored in the storage device and changing the combination of the conversion circuits for the data conversion.

16. A data processing method in a control system including a plurality of processors which include an own processor and conduct arithmetic operation processing by using data including programs described for a plurality of different processors, a storage device for storing data, a conversion unit having a plurality of conversion circuits which is responsive to data in the storage device different from data for some processor for converting the data different from data for the processor to data for some processor, and a control unit for managing changeover of data transmission to and reception between the plurality of processors and the storage device, the conversion unit comprising changeover units for changing over a conversion method by combining the plurality of conversion circuits according to a kind of data stored in the storage device, the data processing method in control system comprising;
in response to data in the storage device which differs from the data for some processor,
converting the data to a data format which can be executed by the some processor and conducting processing on resultant data.

17. The data processing method in control system according to claim 16, wherein if a program in the storage device is different from the program for the some processor when converting a program for another processor stored in the storage device to a program for the own processor in the control system, then data of the program is taken out, a conversion method of the data is determined in accordance with a conversion program in the storage device, and the data is converted to a data format which can be executed by some processor in the control system.
